(19) United States
(12) Patent Application Publication
(10) Pub. No.: US 2026/0266653 A1
(43) Pub. Date: Sep. 10, 2026

(54) SENSING SYSTEM, SENSING DEVICE, AND SENSING METHOD

(71) Applicant: NEC Corporation, Minato-ku, Tokyo (JP)

(72) Inventors: Tadayuki IWANO, Tokyo (JP); Naoto SAEKI, Tokyo (JP)

(73) Assignee: NEC Corporation, Minato-ku, Tokyo (JP)

(21) Appl. No.: 18/871,872

(22) PCT Filed: Jun. 30, 2022
(86) PCT No.: PCT/JP2022/026166

§ 371 Date: Dec. 5, 2024

(51) Int. Cl. G01H 9/00; G01D 5/353

(52) U.S. Cl. CPC G01H 9/004; G01D 5/35358

(57) ABSTRACT

A sensing system according to the present disclosure includes: an optical fiber (10) installed in a predetermined region; a communication unit (20) that inputs pulsed light to the optical fiber (10), and receives backscattered light with respect to the pulsed light from the optical fiber (10); and an identification unit (30) that identifies a normal state of the predetermined region based on vibration information included in the backscattered light, the vibration information indicating a vibration intensity or a vibration frequency per unit time at each position on the optical fiber (10).

### TECHNICAL FIELD

The present disclosure relates to a sensing system, a sensing device, and a sensing method.

### BACKGROUND ART

In recent years, a technology called optical fiber sensing using an optical fiber as a sensor has been developed. In the optical fiber sensing, it is possible to detect an abnormality that has occurred around the optical fiber by detecting vibrations and sounds around the optical fiber.

As a technology for detecting an abnormality by optical fiber sensing, there is a technology disclosed in Patent Literature 1.

The technology disclosed in Patent Literature 1 is a technology for detecting unlicensed construction work. Specifically, in the technology disclosed in Patent Literature 1, a vibration pattern that occurs during construction work is carried out in a combination of different construction models is identified and stored, a combination of different construction models used in reported construction work is stored, and unlicensed construction work is detected using the stored information.

### CITATION LIST

### Patent Literature

Patent Literature 1: International Patent Publication No. WO2021/010251

### SUMMARY OF INVENTION

### Technical Problem

However, in the technology disclosed in Patent Literature 1, a vibration pattern generated by construction work is identified, and a place where an abnormality is detected is limited to a construction site. Therefore, there is a problem that an abnormality cannot be detected in any region other than the construction site.

In view of the foregoing problem, an object of the present disclosure is to provide a sensing system, a sensing device, and a sensing method capable of contributing to detecting an abnormality in any region.

### Solution to Problem

A sensing system according to one aspect includes:
an optical fiber installed in a predetermined region;
a communication unit configured to input pulsed light to the optical fiber, and receive backscattered light with respect to the pulsed light from the optical fiber; and
an identification unit configured to identify a normal state of the predetermined region based on vibration information included in the backscattered light, the vibration information indicating a vibration intensity or a vibration frequency per unit time at each position on the optical fiber.

A sensing device according to one aspect includes:
a communication unit configured to input pulsed light to an optical fiber installed in a predetermined region, and receive backscattered light with respect to the pulsed light from the optical fiber; and
an identification unit configured to identify a normal state of the predetermined region based on vibration information included in the backscattered light, the vibration information indicating a vibration intensity or a vibration frequency per unit time at each position on the optical fiber.

A sensing method performed by a sensing device according to one aspect includes:
a communication step of inputting pulsed light to an optical fiber installed in a predetermined region, and receiving backscattered light with respect to the pulsed light from the optical fiber; and
a first identification step of identifying a normal state of the predetermined region based on vibration information included in the backscattered light, the vibration information indicating a vibration intensity or a vibration frequency per unit time at each position on the optical fiber.

### Advantageous Effects of Invention

According to the above-described aspects, it is possible to provide a sensing system, a sensing device, and a sensing method capable of contributing to detecting an abnormality in any region.

### BRIEF DESCRIPTION OF DRAWINGS

FIG. 1 is a diagram illustrating an example of a configuration of a sensing system according to a first example embodiment.

FIG. 2 is a diagram illustrating an example of vibration information in a normal state according to the first example embodiment.

FIG. 3 is a flowchart illustrating an example of a flow of schematic operations of the sensing system according to the first example embodiment.

FIG. 4 is a diagram illustrating an example of a configuration of a sensing system according to a second example embodiment.

FIG. 5 is a flowchart illustrating an example of a flow of schematic operations of the sensing system according to the second example embodiment.

FIG. 6 is a diagram illustrating an example of a configuration of a sensing system according to a third example embodiment.

FIG. 7 is a diagram illustrating an example of a relationship between vibration information in a normal state and a threshold according to the third example embodiment.

FIG. 8 is a flowchart illustrating an example of a flow of schematic operations of the sensing system according to the third example embodiment.

FIG. 9 is a diagram illustrating an example of a configuration of a sensing system according to a fourth example embodiment.

FIG. 10 is a flowchart illustrating an example of a flow of schematic operations of the sensing system according to the fourth example embodiment.

FIG. 11 is a diagram illustrating an example of configuration of a sensing system according to another example embodiment.

FIG. 12 is a block diagram illustrating an example of a hardware configuration of a computer that implements a sensing device according to another example embodiment.

### EXAMPLE EMBODIMENT

Hereinafter, example embodiments of the present disclosure will be described with reference to the drawings. Note that, in the following description and drawings, omission and simplification are made as appropriate, for clarity of explanation. Furthermore, in the following drawings, the same elements will be denoted by the same reference signs, and redundant description will be omitted as necessary.

### First Example Embodiment

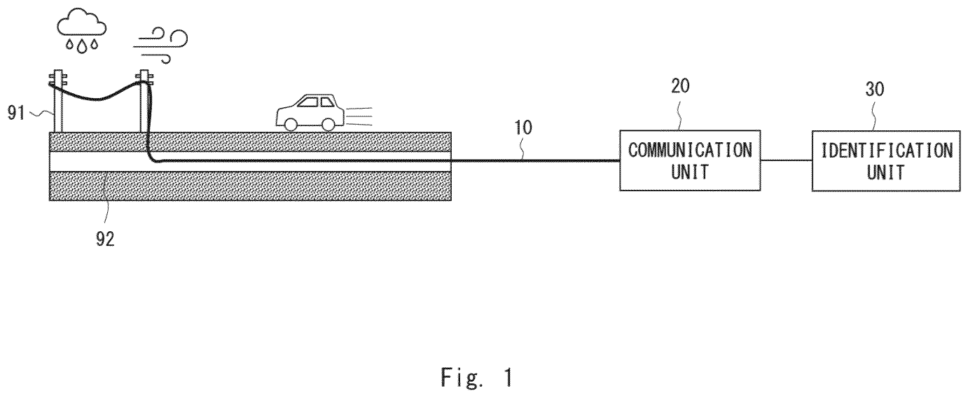

First, an example of a configuration of a sensing system according to a first example embodiment will be described with reference to FIG. 1.

As illustrated in FIG. 1, the sensing system according to the first example embodiment includes an optical fiber 10, a communication unit 20, and an identification unit 30. Note that, in FIG. 1, it is assumed that the communication unit 20 and the identification unit 30 are separately provided. The identification unit 30 may be provided in an apparatus different from the communication unit 20, or may be provided on a cloud.

The optical fiber 10 is installed in a region where an abnormality is desired to be detected. The optical fiber 10 may be disposed overhead or buried in the ground, or a partial portion thereof may be disposed overhead and the rest may be buried in the ground. In the example of FIG. 1, a partial portion of the optical fiber 10 is suspended on a utility pole 91, and the rest of the optical fiber 10 passes through an underground pipe line 92. In addition, the optical fiber 10 may be installed in the form of an optical fiber cable configured by coating the optical fiber 10. In addition, one end of the optical fiber 10 is connected to the communication unit 20.

The communication unit 20 transmits pulsed light to the optical fiber 10. Then, as the pulsed light is transmitted through the optical fiber 10, backscattered light is generated. The communication unit 20 receives the backscattered light from the optical fiber 10.

The identification unit 30 can calculate a position on the optical fiber 10 where the backscattered light is generated (a length of the optical fiber 10 from the communication unit 20), based on a time difference between a time when the pulsed light is transmitted to the optical fiber 10 by the communication unit 20 and a time when the backscattered light is received from the optical fiber 10 by the communication unit 20.

In the portion disposed overhead of the optical fiber 10, vibrations are generated, for example, during the portion is exposed to rain, wind, or the like. In addition, vibrations are also generated in the portion buried in the ground, for example, during a vehicle travels on a road immediately above the portion buried in the ground. In a case where vibrations are generated in the optical fiber 10, the characteristic (e.g., wavelength) of the backscattered light transmitted through the optical fiber 10 changes.

Therefore, the identification unit 30 can calculate a vibration intensity or a vibration frequency at the position where the backscattered light is generated on the optical fiber 10 by analyzing the characteristic of the backscattered light. Furthermore, the identification unit 30 can calculate a vibration intensity or a vibration frequency per unit time at each position on the optical fiber 10 based on the time course of the vibration intensity or the vibration frequency at each position on the optical fiber 10.

Therefore, the identification unit 30 can acquire vibration information indicating the vibration intensity or the vibration frequency per unit time at each position on the optical fiber 10 by analyzing the characteristic of the backscattered light. In other words, the vibration information is included in the backscattered light, and the identification unit 30 can acquire the vibration information included in the backscattered light by analyzing the characteristic of the backscattered light.

Therefore, by analyzing backscattered light received by the communication unit 20 in a normal state where no abnormality occurs in the region where the optical fiber 10 is installed, the identification unit 30 acquires vibration information in the normal state for the region where the optical fiber 10 is installed.

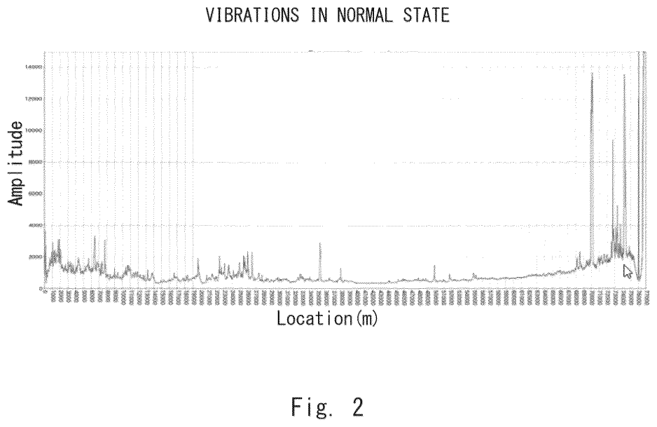

FIG. 2 illustrates an example of vibration information acquired in a normal state by the identification unit 30. In the example of FIG. 2, the vibration information indicates a vibration intensity per unit time. In FIG. 2, the horizontal axis represents a position on the optical fiber 10 (a length of the optical fiber 10 from the communication unit 20), and the vertical axis represents a vibration intensity per unit time. Specifically, in FIG. 2, the vertical axis represents an average vibration intensity per unit time (e.g., about 30 seconds) over several days (e.g., about one week).

After acquiring the vibration information as illustrated in FIG. 2, the identification unit 30 identifies a normal state of the region where the optical fiber 10 is installed based on the vibration information. That is, the identification unit 30 identifies the state indicated by the vibration information as illustrated in FIG. 2 as a normal state.

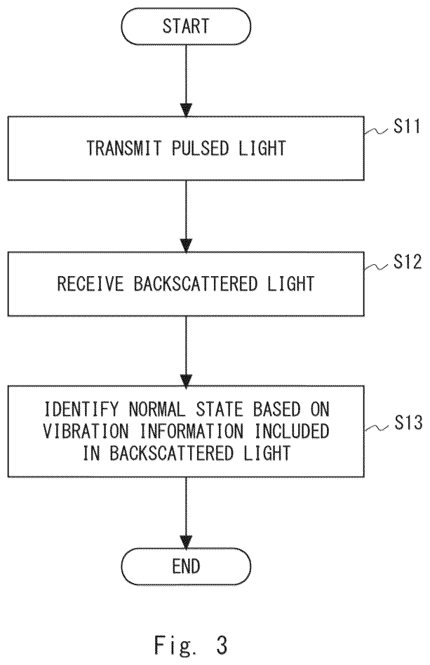

Next, an example of a flow of schematic operations of the sensing system according to the first example embodiment will be described with reference to FIG. 3.

As illustrated in FIG. 3, first, the communication unit 20 transmits pulsed light to the optical fiber 10 (step S11), and receives backscattered light with respect to the pulsed light from the optical fiber 10 (step S12).

Thereafter, the identification unit 30 acquires vibration information indicating a vibration intensity or a vibration frequency per unit time at each position on the optical fiber 10 included in the backscattered light by analyzing the characteristic of the backscattered light, and identifies a normal state of a region where the optical fiber 10 is installed based on the acquired vibration information (step S13).

As described above, according to the first example embodiment, the communication unit 20 transmits pulsed light to the optical fiber 10, and receives backscattered light with respect to the pulsed light from the optical fiber 10. The identification unit 30 identifies a normal state of a region where the optical fiber 10 is installed, based on vibration information included in the backscattered light and indicating a vibration intensity or a vibration frequency per unit time at each position on the optical fiber 10.

As a result, in a case where an abnormality is detected in a certain region where the optical fiber 10 is installed, the abnormality can be detected using the normal state identified for the region. Therefore, it is possible to contribute to abnormality detection in any region.

### Second Example Embodiment

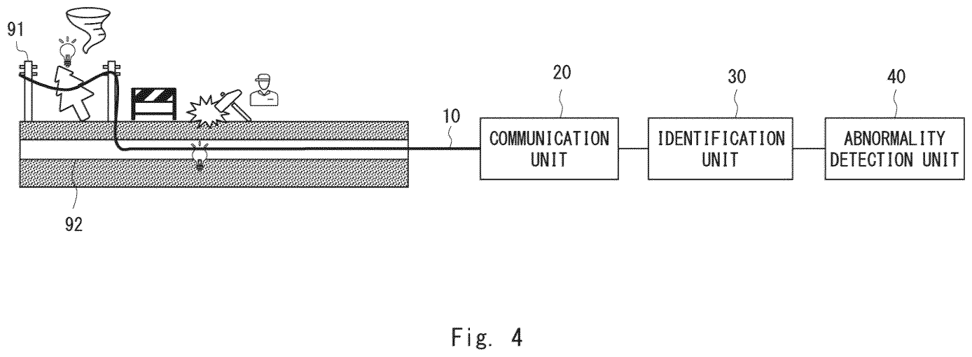

Next, an example of a configuration of a sensing system according to a second example embodiment will be described with reference to FIG. 4.

As illustrated in FIG. 4, the sensing system according to the second example embodiment is different from the configuration of FIG. 1 according to the first example embodiment described above in that an abnormality detection unit 40 is added.

As described above, the identification unit 30 identifies a normal state of a region where the optical fiber 10 is installed. The normal state identified by the identification unit 30 is stored in a memory (not illustrated) or the like.

Furthermore, the identification unit 30 also identifies a current state of the region where the optical fiber 10 is installed based on vibration information included in backscattered light.

As illustrated in FIG. 4, if large vibrations different from those in the normal state are generated, due to the contact of trees with the optical fiber 10 or the collapse of the utility pole 91 due to a storm or the like, or due to the road construction or the like, the vibration information included in the backscattered light changes, and the state identified by the identification unit 30 also changes.

Therefore, the abnormality detection unit 40 compares the current state of the region where the optical fiber 10 is installed with the normal state, and detects whether an abnormality currently occurs in the region where the optical fiber 10 is installed based on the comparison result. For example, in a case where the vibration information indicates a vibration intensity per unit time, if the vibration intensity per unit time is larger than that in the normal state by a predetermined value or more at any position on the optical fiber 10, the abnormality detection unit 40 may determine that an abnormality has occurred at that position.

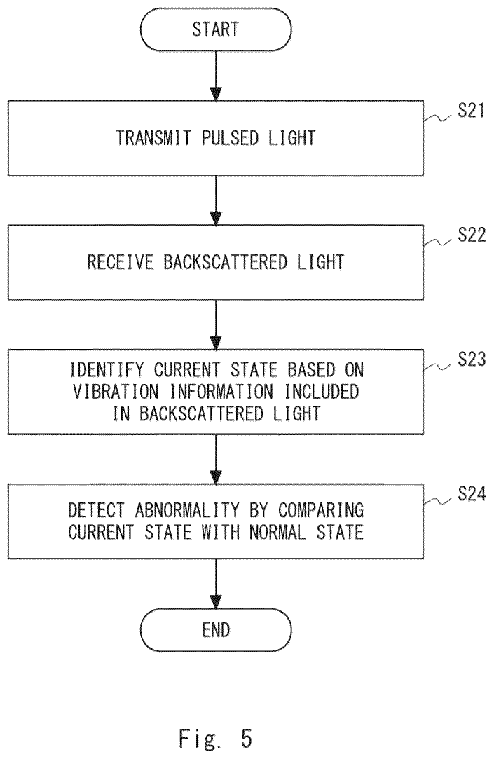

Next, an example of a flow of schematic operations of the sensing system according to the second example embodiment will be described with reference to FIG. 5. Here, the operations will be described, assuming that abnormality detection is performed in a region where the optical fiber 10 is installed in a situation where a normal state of the region has already been identified and the normal state has already been stored in a memory (not illustrated) or the like.

As illustrated in FIG. 5, first, the communication unit 20 transmits pulsed light to the optical fiber 10 (step S21), and receives backscattered light with respect to the pulsed light from the optical fiber 10 (step S22).

Next, the identification unit 30 acquires vibration information indicating a vibration intensity or a vibration frequency per unit time at each position on the optical fiber 10 included in the backscattered light by analyzing the characteristic of the backscattered light, and identifies a current state of a region where the optical fiber 10 is installed based on the acquired vibration information (step S23).

Thereafter, the abnormality detection unit 40 compares the current state of the region where the optical fiber 10 is installed with the normal state, and detects whether an abnormality currently occurs in the region where the optical fiber 10 is installed based on the comparison result (step S24).

As described above, according to the second example embodiment, the identification unit 30 identifies in advance a normal state of a region where the optical fiber 10 is installed based on vibration information included in backscattered light. Then, the identification unit 30 identifies a current state of the region where the optical fiber 10 is installed based on vibration information included in backscattered light. The abnormality detection unit 40 detects an abnormality in the region where the optical fiber 10 is installed by comparing the current state of the region where the optical fiber 10 is installed with the normal state. As a result, it is possible to detect an abnormality in any region where the optical fiber 10 is installed.

### Third Example Embodiment

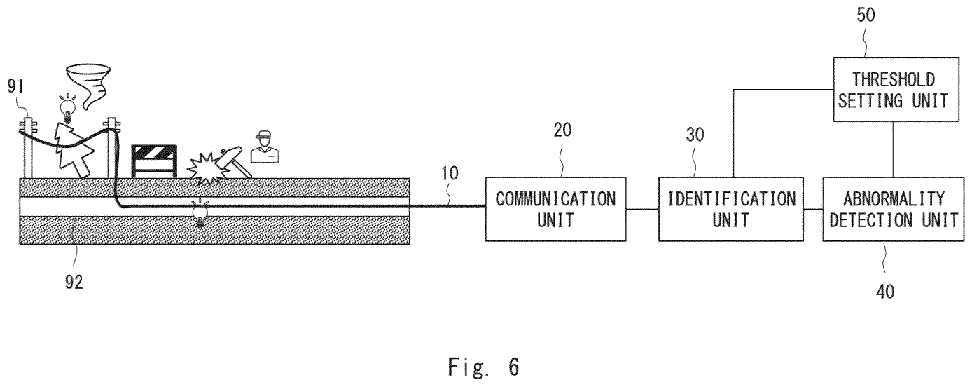

Next, an example of a configuration of a sensing system according to a third example embodiment will be described with reference to FIG. 6.

As illustrated in FIG. 6, the sensing system according to the third example embodiment is different from the configuration of FIG. 4 according to the second example embodiment described above in that a threshold setting unit 50 is added.

As described above, the identification unit 30 identifies a normal state of a region where the optical fiber 10 is installed.

The threshold setting unit 50 sets a threshold corresponding to the normal state of the region where the optical fiber 10 is installed. For example, in a case where the vibration information indicates a vibration intensity per unit time, the threshold may be set to a value about 1.5 times the vibration intensity at each position on the optical fiber 10 in the vibration information in the normal state.

The threshold set by the threshold setting unit 50 is stored in a memory (not illustrated) or the like.

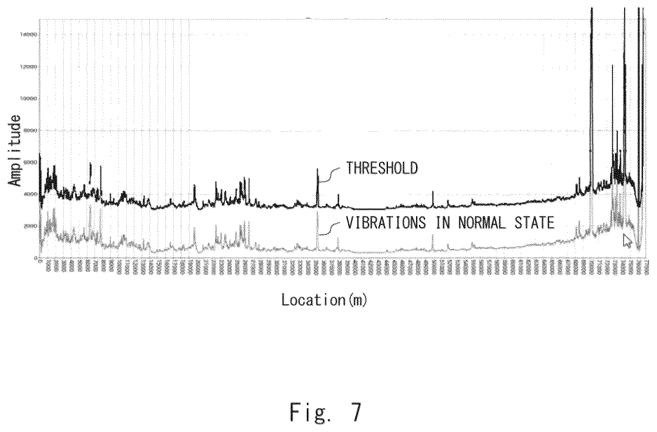

FIG. 7 illustrates an example of a relationship between the vibration information in the normal state acquired by the identification unit 30 and the threshold set by the threshold setting unit 50. In FIG. 7, the horizontal axis and the vertical axis are similar to the horizontal axis and the vertical axis in FIG. 2.

The identification unit 30 also identifies a current state of the region where the optical fiber 10 is installed based on vibration information included in backscattered light.

The abnormality detection unit 40 compares the current state of the region where the optical fiber 10 is installed with the threshold, and detects whether an abnormality currently occurs in the region where the optical fiber 10 is installed based on the comparison result. For example, in a case where the vibration information indicates a vibration intensity per unit time, if the vibration intensity per unit time is larger than the threshold at any position on the optical fiber 10, the abnormality detection unit 40 may determine that an abnormality has occurred at that position.

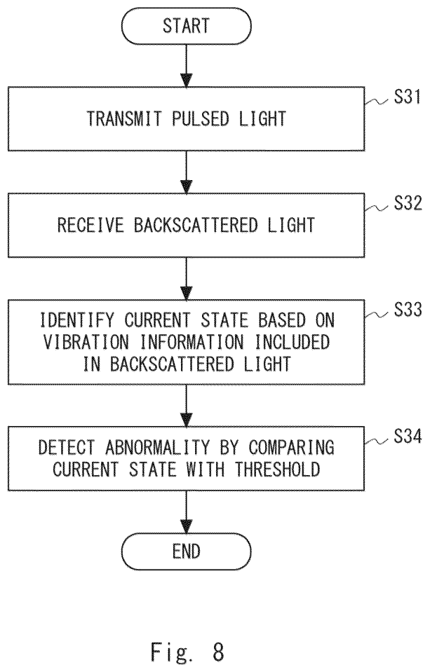

Next, an example of a flow of schematic operations of the sensing system according to the third example embodiment will be described with reference to FIG. 8. Here, the operations will be described, assuming that abnormality detection is performed in a region where the optical fiber 10 is installed in a situation where a threshold for the region has already been set and the threshold has already been stored in a memory (not illustrated) or the like.

As illustrated in FIG. 8, first, the processing of steps S31 to S33 that is similar to the processing of steps S21 to S23 in FIG. 5 according to the second example embodiment described above is performed.

Thereafter, the abnormality detection unit 40 compares the current state of the region where the optical fiber 10 is installed with the threshold, and detects whether an abnormality currently occurs in the region where the optical fiber 10 is installed based on the comparison result (step S34).

As described above, according to the third example embodiment, the identification unit 30 identifies in advance a normal state of a region where the optical fiber 10 is installed based on vibration information included in backscattered light, and the threshold setting unit 50 sets in advance a threshold corresponding to the identified normal state. Then, the identification unit 30 identifies a current state of the region where the optical fiber 10 is installed based on vibration information included in backscattered light. The abnormality detection unit 40 detects an abnormality in the region where the optical fiber 10 is installed by comparing the current state of the region where the optical fiber 10 is installed with the threshold. As a result, it is possible to detect an abnormality in any region where the optical fiber 10 is installed.

### Fourth Example Embodiment

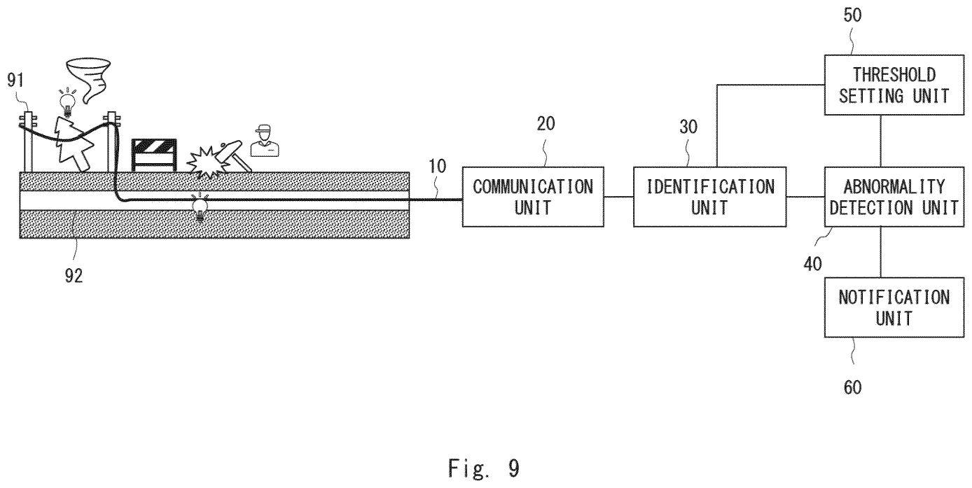

Next, an example of a configuration of a sensing system according to a fourth example embodiment will be described with reference to FIG. 9.

As illustrated in FIG. 9, the sensing system according to the fourth example embodiment is different from the configuration of FIG. 6 according to the third example embodiment described above in that a notification unit 60 is added.

In a case where the abnormality detection unit 40 determines that an abnormality has occurred in the region where the optical fiber 10 is installed, the notification unit 60 notifies a predetermined notification destination of the occurrence of the abnormality in the region. At this time, the notification unit 60 may notify the predetermined notification destination of a position where the abnormality has occurred as well as the occurrence of the abnormality in the region where the optical fiber 10 is installed. The predetermined notification destination may be, for example, a terminal installed in a management center that manages the region where the optical fiber 10 is installed, a local public entity, a country, or the like. In addition, the notification method may be, for example, a method of displaying a graphical user interface (GUI) screen on a display, a monitor, or the like of the terminal of the notification destination, or a method of outputting a message by voice from a speaker of the terminal of the notification destination.

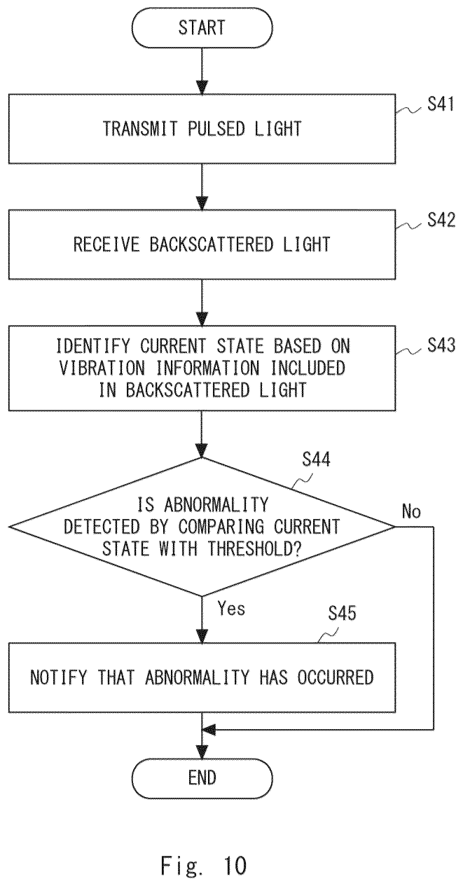

Next, an example of a flow of schematic operations of the sensing system according to the fourth example embodiment will be described with reference to FIG. 10.

As illustrated in FIG. 10, first, the processing of steps S41 to S44 that is similar to the processing of steps S31 to S34 in FIG. 8 according to the third example embodiment described above is performed.

In step S44, in a case where the abnormality detection unit 40 determines that an abnormality has occurred in the region where the optical fiber 10 is installed (Yes in step S44), the notification unit 60 notifies a predetermined notification destination of the occurrence of the abnormality (step S45).

As described above, according to the fourth example embodiment, in a case where the abnormality detection unit 40 determines that an abnormality has occurred in a region where the optical fiber 10 is installed, the notification unit 60 notifies a predetermined notification destination of the occurrence of the abnormality in the region. As a result, a management center or the like that manages the region can be notified of the occurrence of the abnormality.

In addition, the notification unit 60 may notify the predetermined notification destination of a position where the abnormality has occurred as well as the occurrence of the abnormality in the region where the optical fiber 10 is installed. As a result, the personnel of the management center or the like can quickly rush to the site where the abnormality has occurred.

The other effects are similar to the effects according to the third example embodiment described above.

### Other Example Embodiments

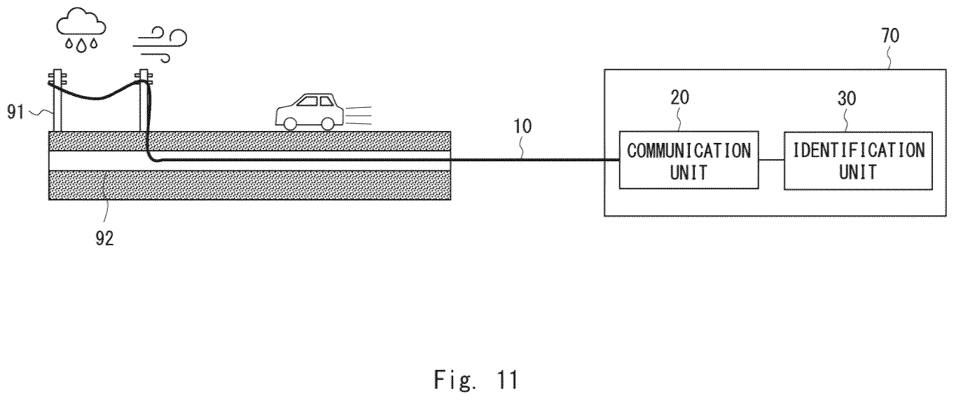

In the first example embodiment described above, the communication unit 20 and the identification unit 30 are separately provided, but the communication unit 20 and the identification unit 30 may be provided in the same apparatus. FIG. 11 illustrates an example of a configuration of a sensing system in which the communication unit 20 and the identification unit 30 are provided inside a sensing device 70. Note that, in the sensing system illustrated in FIG. 11, the abnormality detection unit 40, the threshold setting unit 50, the notification unit 60, etc. according to the second, third, and fourth example embodiments described above may be added to the inside of the sensing device 70.

In addition, even in the same region where the optical fiber 10 is installed, the vibration state may vary greatly with time. For example, the volume of vehicle traffic traveling on a road differs between morning and night, and may also differ depending on the day of the week.

Therefore, the identification unit 30 may identify a normal state for each day of the week or for each time section, and the threshold setting unit 50 may set a threshold for each day of the week or for each time section. In this case, the abnormality detection unit 40 may detect an abnormality by comparing a current state with the threshold corresponding to the current day of the week or the current time section.

In addition, in the region where the optical fiber 10 is installed, abnormal vibrations may be generated regularly for a short period of time. For example, a sound of a passing a train or a warning sound of crossing gate at a railroad crossing does not continue for one minute or more.

Therefore, the identification unit 30, the abnormality detection unit 40, and the threshold setting unit 50 may detect only vibrations that have continued for a predetermined period of time or more as an abnormality. That is, the identification unit 30 may remove vibrations that have not continued for the predetermined period of time or more from the vibration information, and identify a normal state or a current state based on the vibration information after the removal. In this case, the threshold setting unit 50 may set a threshold based on the normal state identified from the vibration information after the removal. In addition, the abnormality detection unit 40 may detect an abnormality by comparing the current state identified from the vibration information after the removal with the threshold set from the vibration information after the removal.

In addition, in the region where the optical fiber 10 is installed, abnormal vibrations may be generated irregularly.

Therefore, the identification unit 30, the abnormality detection unit 40, and the threshold setting unit 50 may learn a vibration pattern of abnormal vibrations generated irregularly, and detect only vibrations other than the vibrations having the learned vibration pattern as an abnormality. That is, the identification unit 30 may learn a vibration pattern of abnormal vibrations generated irregularly, extract only vibrations other than the vibrations having the learned vibration pattern from the vibration information, and identify a normal state or a current state based on the vibration information after the extraction. In this case, the threshold setting unit 50 may set a threshold based on the normal state identified from the vibration information after the extraction. In addition, the abnormality detection unit 40 may detect an abnormality by comparing the current state identified from the vibration information after the extraction with the threshold set from the vibration information after the extraction.

### Hardware Configuration of Sensing Device According To Example Embodiment

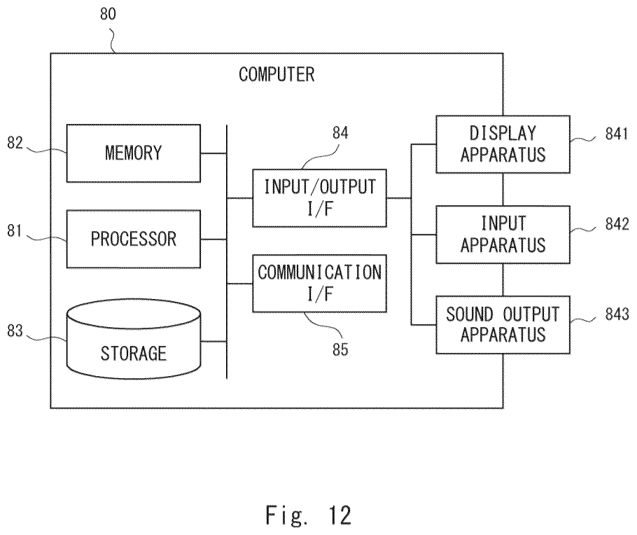

Next, an example of a hardware configuration of a computer 80 that implements the sensing device 70 according to another example embodiment described above (FIG. 11) will be described with reference to FIG. 12.

As illustrated in FIG. 12, the computer 80 includes a processor 81, a memory 82, a storage 83, an input/output interface (input/output I/F) 84, a communication interface (communication I/F) 85, and the like. The processor 81, the memory 82, the storage 83, the input/output interface 84, and the communication interface 85 are connected to each other by a data transmission path for mutually transmitting or receiving data.

The processor 81 is an arithmetic processing apparatus such as a central processing unit (CPU) or a graphics processing unit (GPU). The memory 82 is a memory such as a random access memory (RAM) or a read only memory (ROM). The storage 83 is, for example, a storage device such as a hard disk drive (HDD), a solid state drive (SSD), or a memory card. Furthermore, the storage 83 may be a memory such as a RAM or a ROM.

A program is stored in the storage 83. This program includes a command group (or software code) for causing the computer 80 to perform one or more functions of the sensing device 70 described above, in a case where being read by the computer. The components in the sensing device 70 described above may be implemented by the processor 81 reading and executing the program stored in the storage 83. Also, the storage function in the sensing device 70 described above may be implemented by the memory 82 or the storage 83.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 84 is connected to a display apparatus 841, an input apparatus 842, a sound output apparatus 843, and the like. The display apparatus 841 is an apparatus that displays a screen corresponding to depiction data processed by the processor 81, such as a liquid crystal display (LCD), a cathode ray tube (CRT) display, or a monitor. The input apparatus 842 is an apparatus that receives an operation input of an operator, and is, for example, a keyboard, a mouse, a touch sensor, or the like. The display apparatus 841 and the input apparatus 842 may be integrated and implemented as a touch panel. The sound output apparatus 843 is an apparatus that acoustically outputs a sound that corresponds to acoustic data processed by the processor 81, such as a speaker.

The communication interface 85 transmits or receives data to and from an external apparatus. For example, the communication interface 85 communicates with an external apparatus via a wired communication path or a wireless communication path.

The present disclosure has been described above with reference to the example embodiments, but the present disclosure is not limited to the example embodiments described above. Various modifications that can be understood by those skilled in the art can be made to the configurations and details of the present disclosure within the scope of the present disclosure. For example, some or all of the above-described example embodiments may be used in combination.

In addition, some or all of the above-described example embodiments may be described in the following supplementary notes, but are not limited thereto.

### Supplementary Note 1

A sensing system including:
an optical fiber installed in a predetermined region;
a communication unit configured to input pulsed light to the optical fiber, and receive backscattered light with respect to the pulsed light from the optical fiber; and
an identification unit configured to identify a normal state of the predetermined region based on vibration information included in the backscattered light, the vibration information indicating a vibration intensity or a vibration frequency per unit time at each position on the optical fiber.

### Supplementary Note 2

The sensing system according to supplementary note 1, further including an abnormality detection unit, in which
the identification unit identifies a current state of the predetermined region based on the vibration information, and
the abnormality detection unit detects an abnormality in the predetermined region by comparing the current state of the predetermined region with the normal state.

### Supplementary Note 3

The sensing system according to supplementary note 1, further including:
an abnormatlity detection unit; and
a threshold setting unit configured to set a threshold corresponding to the normal state of the predetermined region, in which
the identification unit identifies a current state of the predetermined region based on the vibration information, and
the abnormality detection unit detects an abnormality in the predetermined region by comparing the current state of the predetermined region with the threshold.

### Supplementary Note 4

The sensing system according to supplementary note 3, in which
the identification unit identifies the normal state of the predetermined region for each day of the week or for each time section,
the threshold setting unit sets the threshold for each day of the week or for each time section, and
the abnormality detection unit detects the abnormality in the predetermined region by comparing the current state of the predetermined region with the threshold corresponding to a current day of the week or a current time section.

### Supplementary Note 5

The sensing system according to supplementary note 2 or 3, in which the identification unit removes vibrations that have not continued for a predetermined period of time or more from the vibration information, and identifies the normal state and the current state of the predetermined region based on the vibration information after the removal.

### Supplementary Note 6

The sensing system according to supplementary note 2 or 3, in which the identification unit learns a vibration pattern of abnormal vibrations generated irregularly, extracts vibrations other than the vibrations having the learned vibration pattern from the vibration information, and identifies the normal state and the current state of the predetermined region based on the vibration information after the extraction.

### Supplementary Note 7

The sensing system according to supplementary note 2 or 3, further including a notification unit configured to notify a predetermined notification destination that an abnormality has occurred in the predetermined region in a case where the abnormality detection unit determines that the abnormality has occurred in the predetermined region.

### Supplementary Note 8

A sensing device including:
a communication unit configured to input pulsed light to an optical fiber installed in a predetermined region, and receive backscattered light with respect to the pulsed light from the optical fiber; and
an identification unit configured to identify a normal state of the predetermined region based on vibration information included in the backscattered light, the vibration information indicating a vibration intensity or a vibration frequency per unit time at each position on the optical fiber.

### Supplementary Note 9

The sensing device according to supplementary note 8, further including an abnormality detection unit, in which
the identification unit identifies a current state of the predetermined region based on the vibration information, and
the abnormality detection unit detects an abnormality in the predetermined region by comparing the current state of the predetermined region with the normal state.

### Supplementary Note 10

The sensing device according to supplementary note 8, further including:
an abnormality detection unit; and
a threshold setting unit configured to set a threshold corresponding to the normal state of the predetermined region, in which
the identification unit identifies a current state of the predetermined region based on the vibration information, and
the abnormality detection unit detects an abnormality in the predetermined region by comparing the current state of the predetermined region with the threshold.

### Supplementary Note 11

The sensing device according to supplementary note 10, in which
the identification unit identifies the normal state of the predetermined region for each day of the week or for each time section,
the threshold setting unit sets the threshold for each day of the week or for each time section, and
the abnormality detection unit detects the abnormality in the predetermined region by comparing the current state of the predetermined region with the threshold corresponding to a current day of the week or a current time section.

### Supplementary Note 12

The sensing device according to supplementary note 9 or 10, in which the identification unit removes vibrations that have not continued for a predetermined period of time or more from the vibration information, and identifies the normal state and the current state of the predetermined region based on the vibration information after the removal.

### Supplementary Note 13

The sensing device according to supplementary note 9 or 10, in which the identification unit learns a vibration pattern of abnormal vibrations generated irregularly, extracts vibrations other than the vibrations having the learned vibration pattern from the vibration information, and identifies the normal state and the current state of the predetermined region based on the vibration information after the extraction.

### Supplementary Note 14

The sensing device according to supplementary note 9 or 10, further including a notification unit configured to notify a predetermined notification destination that an abnormality has occurred in the predetermined region in a case where the abnormality detection unit determines that the abnormality has occurred in the predetermined region.

### Supplementary Note 15

A sensing method performed by a sensing device, the sensing method including:
a communication step of inputting pulsed light to an optical fiber installed in a predetermined region, and receiving backscattered light with respect to the pulsed light from the optical fiber; and
a first identification step of identifying a normal state of the predetermined region based on vibration information included in the backscattered light, the vibration information indicating a vibration intensity or a vibration frequency per unit time at each position on the optical fiber.

### Supplementary Note 16

The sensing method according to supplementary note 15, further including:
a second identification step of identifying a current state of the predetermined region based on the vibration information; and
an abnormality detection step of detecting an abnormality in the predetermined region by comparing the current state of the predetermined region with the normal state.

### Supplementary Note 17

The sensing method according to supplementary note 15, further including:
a threshold setting step of setting a threshold corresponding to the normal state of the predetermined region;
a second identification step of identifying a current state of the predetermined region based on the vibration information; and
an abnormality detection step of detecting an abnormality in the predetermined region by comparing the current state of the predetermined region with the threshold.

### Supplementary Note 18

The sensing method according to supplementary note 17, in which
in the first identification step, the normal state of the predetermined region is identified for each day of the week or for each time section,
in the threshold setting step, the threshold is set for each day of the week or for each time section, and
in the abnormality detection step, the abnormality in the predetermined region is detected by comparing the current state of the predetermined region with the threshold corresponding to a current day of the week or a current time section.

### Supplementary Note 19

The sensing method according to supplementary note 16 or 17, in which
in the first identification step, vibrations that have not continued for a predetermined period of time or more are removed from the vibration information, and the normal state of the predetermined region is identified based on the vibration information after the removal, and
in the second identification step, vibrations that have not continued for the predetermined period of time or more are removed from the vibration information, and the current state of the predetermined region is identified based on the vibration information after the removal.

### Supplementary Note 20

The sensing method according to supplementary note 16 or 17, further including a learning step of learning a vibration pattern of abnormal vibrations generated irregularly, in which
in the first identification step, vibrations other than the vibrations having the vibration pattern learned in the learning step are extracted from the vibration information, and the normal state of the predetermined region is identified based on the vibration information after the extraction, and
in the second identification step, vibrations other than the vibrations having the vibration pattern learned in the learning step are extracted from the vibration information, and the current state of the predetermined region is identified based on the vibration information after the extraction.

### Supplementary Note 21

The sensing method according to supplementary note 16 or 17, further including a notification step of notifying a predetermined notification destination that an abnormality has occurred in the predetermined region in a case where it is determined in the abnormality detection step that the abnormality has occurred in the predetermined region.

### REFERENCE SIGNS LIST

10 OPTICAL FIBER
20 COMMUNICATION UNIT
30 IDENTIFICATION UNIT
40 ABNORMALITY DETECTION UNIT
50 THRESHOLD SETTING UNIT
60 NOTIFICATION UNIT
70 SENSING DEVICE
80 COMPUTER
81 PROCESSOR
83 STORAGE
84 INPUT/OUTPUT INTERFACE
841 DISPLAY APPARATUS
842 INPUT APPARATUS
843 SOUND OUTPUT APPARATUS
85 COMMUNICATION INTERFACE
91 UTILITY POLE
92 UNDERGROUND PIPE LINE

What is claimed is:

1. A sensing system comprising:
an optical fiber installed in a predetermined region;
at least one memory storing instructions, and
at least one processor configured to execute the instructions to;
input pulsed light to the optical fiber, and receive backscattered light with respect to the pulsed light from the optical fiber; and
identify a normal state of the predetermined region based on vibration information included in the backscattered light, the vibration information indicating a vibration intensity or a vibration frequency per unit time at each position on the optical fiber.

2. The sensing system according to claim 1, wherein the at least one processor is further configured to execute the instructions to
identify a current state of the predetermined region based on the vibration information, and
detect an abnormality in the predetermined region by comparing the current state of the predetermined region with the normal state.

3. The sensing system according to claim 1, wherein the at least one processor is further configured to execute the instructions to
set a threshold corresponding to the normal state of the predetermined region,
identify a current state of the predetermined region based on the vibration information, and
detect an abnormality in the predetermined region by comparing the current state of the predetermined region with the threshold.

4. The sensing system according to claim 3, wherein the at least one processor is further configured to execute the instructions to
identify the normal state of the predetermined region for each day of the week or for each time section,
set the threshold for each day of the week or for each time section, and
detect the abnormality in the predetermined region by comparing the current state of the predetermined region with the threshold corresponding to a current day of the week or a current time section.

5. The sensing system according to claim 2, wherein the at least one processor is further configured to execute the instructions to
remove vibrations that have not continued for a predetermined period of time or more from the vibration information, and
identify the normal state and the current state of the predetermined region based on the vibration information after the removal.

6. The sensing system according to claim 2, wherein the at least one processor is further configured to execute the instructions to
learn a vibration pattern of abnormal vibrations generated irregularly,
extract vibrations other than the vibrations having the learned vibration pattern from the vibration information, and
identify the normal state and the current state of the predetermined region based on the vibration information after the extraction.

7. The sensing system according to claim 2, wherein the at least one processor is further configured to execute the instructions to notify a predetermined notification destination that an abnormality has occurred in the predetermined region in a case where it is determined that the abnormality has occurred in the predetermined region.

8. A sensing device comprising:
at least one memory storing instructions, and
at least one processor configured to execute the instructions to;
input pulsed light to an optical fiber installed in a predetermined region, and receive backscattered light with respect to the pulsed light from the optical fiber; and
identify a normal state of the predetermined region based on vibration information included in the backscattered light, the vibration information indicating a vibration intensity or a vibration frequency per unit time at each position on the optical fiber.

9. The sensing device according to claim 8, wherein the at least one processor is further configured to execute the instructions to
identify a current state of the predetermined region based on the vibration information, and
detect an abnormality in the predetermined region by comparing the current state of the predetermined region with the normal state.

10. The sensing device according to claim 8,
wherein the at least one processor is further configured to execute the instructions to
set a threshold corresponding to the normal state of the predetermined region,
identify a current state of the predetermined region based on the vibration information, and
detect an abnormality in the predetermined region by comparing the current state of the predetermined region with the threshold.

11. The sensing device according to claim 10, wherein the at least one processor is further configured to execute the instructions to
identify the normal state of the predetermined region for each day of the week or for each time section,
set the threshold for each day of the week or for each time section, and
detect the abnormality in the predetermined region by comparing the current state of the predetermined region with the threshold corresponding to a current day of the week or a current time section.

12. The sensing device according to claim 9, wherein the at least one processor is further configured to execute the instructions to
remove vibrations that have not continued for a predetermined period of time or more from the vibration information, and
identify the normal state and the current state of the predetermined region based on the vibration information after the removal.

13. The sensing device according to claim 9, wherein the at least one processor is further configured to execute the instructions to
learn a vibration pattern of abnormal vibrations generated irregularly,
extract vibrations other than the vibrations having the learned vibration pattern from the vibration information, and
identify the normal state and the current state of the predetermined region based on the vibration information after the extraction.

14. The sensing device according to claim 9, wherein the at least one processor is further configured to execute the instructions to notify a predetermined notification destination that an abnormality has occurred in the predetermined region in a case where it is determined that the abnormality has occurred in the predetermined region.

15. A sensing method performed by a sensing device, the sensing method comprising:
a communication step of inputting pulsed light to an optical fiber installed in a predetermined region, and receiving backscattered light with respect to the pulsed light from the optical fiber; and
a first identification step of identifying a normal state of the predetermined region based on vibration information included in the backscattered light, the vibration information indicating a vibration intensity or a vibration frequency per unit time at each position on the optical fiber.

16. The sensing method according to claim 15, further comprising:
a second identification step of identifying a current state of the predetermined region based on the vibration information; and
an abnormality detection step of detecting an abnormality in the predetermined region by comparing the current state of the predetermined region with the normal state.

17. The sensing method according to claim 15, further comprising:
a threshold setting step of setting a threshold corresponding to the normal state of the predetermined region;
a second identification step of identifying a current state of the predetermined region based on the vibration information; and
an abnormality detection step of detecting an abnormality in the predetermined region by comparing the current state of the predetermined region with the threshold.

18. The sensing method according to claim 17, wherein
in the first identification step, the normal state of the predetermined region is identified for each day of the week or for each time section,
in the threshold setting step, the threshold is set for each day of the week or for each time section, and
in the abnormality detection step, the abnormality in the predetermined region is detected by comparing the current state of the predetermined region with the threshold corresponding to a current day of the week or a current time section.

19. The sensing method according to claim 16, wherein
in the first identification step, vibrations that have not continued for a predetermined period of time or more are removed from the vibration information, and the normal state of the predetermined region is identified based on the vibration information after the removal, and
in the second identification step, vibrations that have not continued for the predetermined period of time or more are removed from the vibration information, and the current state of the predetermined region is identified based on the vibration information after the removal.

20. The sensing method according to claim 16, further comprising a learning step of learning a vibration pattern of abnormal vibrations generated irregularly, wherein
in the first identification step, vibrations other than the vibrations having the vibration pattern learned in the learning step are extracted from the vibration information, and the normal state of the predetermined region is identified based on the vibration information after the extraction, and
in the second identification step, vibrations other than the vibrations having the vibration pattern learned in the learning step are extracted from the vibration information, and the current state of the predetermined region is identified based on the vibration information after the extraction.

21. (canceled)
